(19) United States
(12) Patent Application Publication
(10) Pub. No.: US 2005/0205376 A1
(43) Pub. Date: Sep. 22, 2005

(54) Ramp actuator

(76) Inventor: Yves J. Kemper, Bloomfield, MI (US)

Correspondence Address: HUSCH & EPPENBERGER, LLC, 190 CARONDELET PLAZA, SUITE 600, ST. LOUIS, MO, 63105-3441, US

(21) Appl. No.: 11/083,811

(22) Filed: Mar. 18, 2005

Related U.S. Application Data
(60) Provisional application No. 60/554,898, filed on Mar. 19, 2004.
(60) Provisional application No. 60/561,687, filed on Apr. 13, 2004.
(60) Provisional application No. 60/563,323, filed on Apr. 19, 2004.
(60) Provisional application No. 60/563,958, filed on Apr. 21, 2004.

(51) Int. Cl. F16D 21/00

(52) U.S. Cl. 192/48.2; 192/84.6

(57) ABSTRACT

A dual clutch system having a first and a second friction disk and having a first and a second pressure plate is disclosed. The clutch actuator includes a first fixed ramp and second fixed ramp. Each of the first and the second fixed ramps are disposed to closely cooperate with a first bearing and a second bearing, respectively. A first moveable ramp and a second moveable ramp are disposed to closely cooperate with the first bearing and the second bearing respectively. A first release bearing is adapted to move with a first lever. The first release bearing is actuated by movement of the first moveable ramp. A second release bearing is adapted to move a second lever and the second release bearing is actuated by movement of the second moveable ramp. The first and the second levers are disposed to operatively bias the first and second pressure plates. A cover bearing is disposed to support movement of the first and second moveable ramps and the first and second release bearings. Each of the moveable ramps are actuated by a linkage with a separate motor.

### CROSS-REFERENCE TO RELATED APPLICATIONS

This application claims the benefit of U.S. Provisional Application Ser. No. 60/554,898, filed Mar. 19, 2004; U.S. Provisional Application Ser. No. 60/561,687 filed Apr. 13, 2004; U.S. Provisional Application Ser. No. 60/563,323, filed Apr. 19, 2004, and U.S. Provisional Application Ser. No. 60/563,958, filed Apr. 21, 2004.

### STATEMENT REGARDING FEDERALLY SPONSORED RESEARCH OR DEVELOPMENT

Not Applicable.

Appendix

Not Applicable.

### BACKGROUND OF THE INVENTION

1. Field of the Invention

This invention related generally to linear actuation devices and, more particularly, to an actuator system for a dual clutch.

2. Related Art

U.S. Pat. No. 6,012,561 discloses a vehicle transmission having a dual clutch system. The dual clutch system includes first and second flywheels as well as first and second friction disk assemblies and first and second pressure plates for pressing against said first and second friction disk assemblies, respectively. The pressure plates are each operatively engaged by an electromechanical clutch actuator. More particularly, the electromechanical clutch actuator engages a complex cam arrangement to engage one of the pressure plates.

There remains a need in the art for increased simplicity, durability, and economy in starting clutches and their assembly and operation.

### SUMMARY OF THE INVENTION

It is in view of the above problems that the present invention was developed. The invention is an actuator system for starting clutches. The actuator system includes a ball ramp and a motor. The motor controllably rotates the ball ramp by adequate means, which may include, as an example only, a gear train reduction.

As an example only, the actuator system may be applied for the operation of a dual starting clutch system, in which case the first and second clutches are controlled by varying the axial position of their respective control levers. The ball ramps of the actuator systems are preferably, but not necessarily, nested.

The actuator system can be used for the actuation of single or dual clutches loaded by diaphragms or loaded by levers, as well as for the actuation of multi-disc clutch packs, either wet or dry. The motor can be either electric or hydraulic.

In another embodiment of the actuator system, the motor drives the ball ramp through a system of pulleys and prestressed wrap spring coils. The motor has two pulleys which have two distinct diameters, and prestressed bands operatively connecting the two motor pulleys and the ball ramp pulley.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates schematically a dual starting clutch system 100 controlled by a dual ball ramp system 200 actuated by electric motors;

FIG. 2A is a detailed view of the dual ball ramp system 200 illustrated in FIG. 1;

FIG. 2B is another detailed view of the dual ball ramp system 200 illustrated in FIG. 1;

FIG. 3A is a perspective view of the two non rotating nested ramps of the dual ball ramp system 200;

FIG. 3B is a perspective partial view of a dual ball ramp system 200;

FIG. 4A is a perspective view of a generic ball ramp system with spiral tracks;

FIG. 4B illustrates a first position of the balls;

FIG. 4C illustrates a middle position of the balls;

FIG. 4D illustrates a third position of the balls;

FIG. 5A is a schematic of a generic ramp system used to define the notations used in FIGS. 5B to 5G;

FIG. 5B is a graph illustrating control force versus axial control travel for a clutch loaded by levers;

FIG. 5C is a graph illustrating the variation of the control torque consequent to the control force illustrated in FIG. 5B versus its rotation for a constant pitch ball ramp system;

FIG. 5D is a graph illustrating the constant control torque consequent to the control force illustrated in FIG. 5B versus its rotation for a ball ramp system designed with a continuously variable pitch;

FIG. 5E is a graph illustrating the angle of rotation of a ball ramp versus its axial travel;

FIG. 5F is a schematic illustrating the relative extreme positions of the ramps of a continuously variable ball ramp system designed according to the graph of FIG. 5E;

FIG. 6A illustrates an alternate embodiment of the actuator system;

FIG. 6B illustrates a side view of the actuator system of FIG. 6A; and

FIG. 6C illustrates a front view of the actuator system of FIG. 6A with transverse motor mount.

### DETAILED DESCRIPTION OF THE PREFERRED EMBODIMENTS

The following description describes the application of the actuator system 400 to a dual dry starting clutch of the type loaded by a series of control levers distributed circumferentially, and in which one of the clutches is controlled by pulling on its control levers, while the other clutch is controlled by pushing on its control levers.

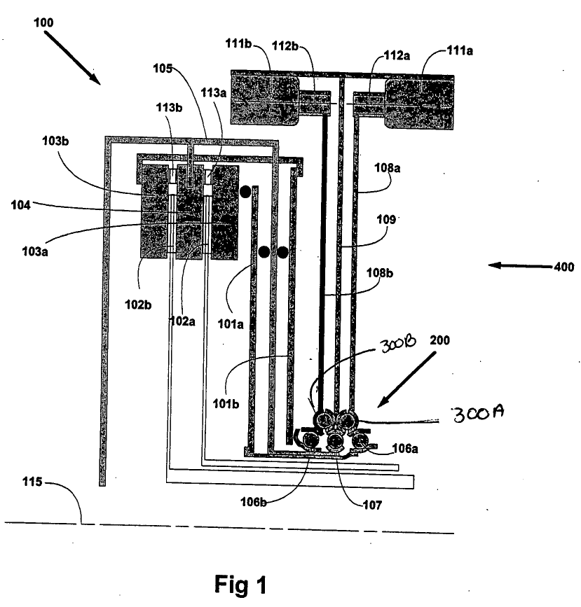

Referring to the accompanying drawings in which like reference numbers indicate like elements, FIG. 1 illustrates a dual clutch system 100 actuated by a dual actuator system 400 composed of a dual ball ramp system 200 and two motors 111a and 111b.

The dual clutch system 100 has a cover 105, a flywheel 104, a first disc 102a, a first pressure plate 103a, a first lever 101a, a second disc 102b, a second pressure plate 103b, and a second lever 101b. Conventionally, the pressure plates 103a and 103b are held rotationally relative to the pressure plate 104, respectively by a series of three circumferential spaced spring straps 113a and 113b. The straps 113a and 113b apply also a relatively constant axial force which pulls apart the pressure plates 103a and 103b away from the flywheel 104.

In the depicted embodiment, a first ball ramp 300a controls the axial position of the first lever 101a through a first release bearing 106a, and a second ball ramp 300b controls the axial position of the second lever 101b through a second release bearing 106b. The first clutch is of the pull type lever 101a, and the second clutch of the push type lever 101b, with the advantage when combined with a cover bearing 107, that the preload of the control bearings 106a and 106b are consequent to the force applied to the levers 101a and 101b by the straps 113a and 113b respectively, and such, does not need separate preload springs located between the clutch housing and the control bearing as for conventional starting clutches.

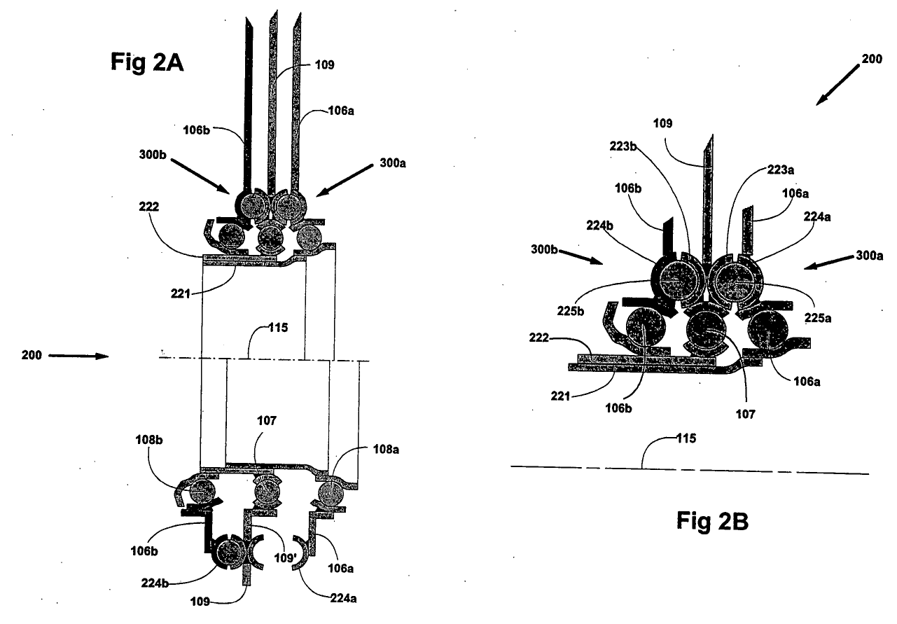

FIGS. 2A and 2B illustrates in greater detail the dual ball ramp system 200 illustrated in FIG. 1. The dual ball ramp system 200 is composed of the first ball ramp system 300a and the second ball ramp system 300b.

The first ball ramp system 300a is composed of a ramp 224a rotatable around the axis of rotation 115 of the dual clutch system 100, a ramp 223a held against rotation relative to the housing of the starting clutch (not illustrated), and one or more balls, one of these being the ball 225a. In the embodiment illustrated in FIG. 1, the ramp 224a is rotatably driven through the gears 112a and 108a. Alternatively, the ramp 224a is operatively connected to a first electric motor 111a by a belt system, or other similar methods. As the ramp 224a rotates, the control bearing 106a moves axially. The control bearing 106a is operatively connected to the first lever 101a through a sleeve 221.

The second ball ramp system 300b is composed of a ramp 224b rotatable around the axis of rotation 115 of the dual clutch system 100, a ramp 223b held against rotation relative to the housing of the starting clutch (not illustrated), and one or more balls, one being of these being the ball 225b. The ramp 224b is rotatably driven by the gears 112b and 108b. As the ramp 224b rotates, the control bearing 106b moves axially. The control bearing 106b is operatively connected to the first lever 101b, and preferably, actuates directly the lever 101b.

The non-rotating ramps 223a and 223b are fastened to a support 109 which is located axially relative to the clutch cover 105 by a cover bearing 107, and is held against rotation relative to the housing (not shown) of the dual clutch system 100 by adequate means. Alternatively, the cover bearing 107 is removed and the support 109 is fastened by adequate means to the housing of the dual clutch system 100, in which case the dual ball ramp system 200 is held relative to the housing of the dual clutch system 100 both rotationally and axially.

The dual ball ramp system 200 is insulated from the rotation of the engine and from the axial vibrations of the engine by the three thrust bearings, i.e., the release bearings 106a and 106b, and the cover bearing 107.

The first and second motors 111a and 111b independently rotate the first and second ramps 224a and 224b, through a preferably a single gear reduction mechanism composed of gears 112a and 112b driven by the motors 111a and 111b, and driving respectively the gears 108a and 108b. Consequent to said rotation, the ramps 224a and 224b move axially, thereby acting on the first and second clutch levers 101a and 101b. Movement of the first and second clutch levers 101a and 101b, correspondingly engages or disengages the respective pressure plate 103a and 103b. Accordingly, the engagement and disengagement of the first and second clutch discs 102a and 102b is controlled by controlling the rotational positions of the first 111a and second 111b motors.

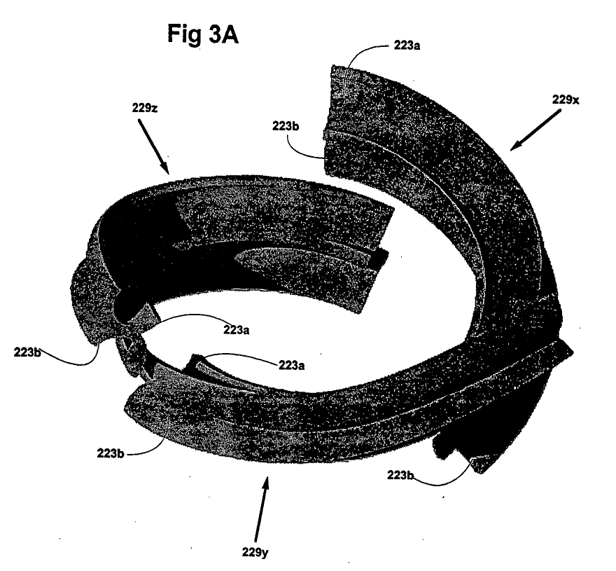

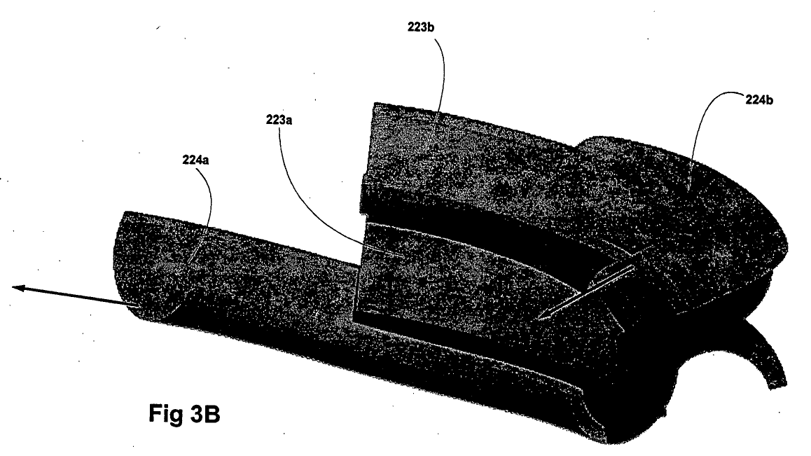

FIG. 3A illustrates how the ramps 223a and 223b are nested together back to back and the tracks of the balls extend circumferentially as well as radially, and how each is composed of preferably three sections 229x, 229y and 229z, each of said sections being fastened by adequate means to the support 109. Because the ramps 223a and 223b are nested, the total axial space required for the ball ramp systems 300a and 300b is substantially reduced.

FIG. 3B illustrates that, because the ramps 223a and 223b are nested, the ramps 224a and 224b rotate in opposite directions. The ramps 223a and 223b are fastened to the cover bearing 107 through three helical circumferential segments, the segment 109′ being visible in the bottom of FIG. 2A. The ramps 223a and 223b are fastened to the support 109 through its three helical sections.

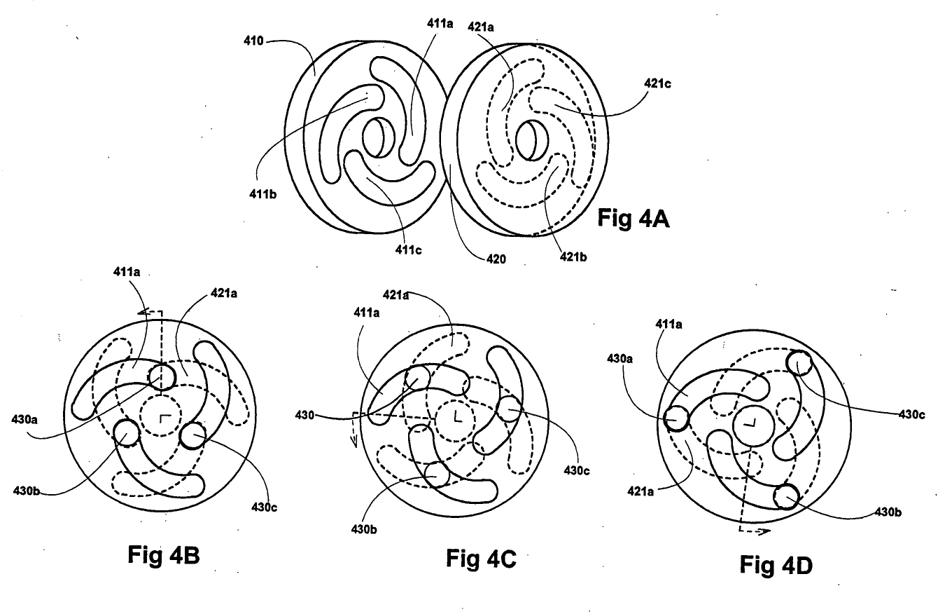

FIG. 4A is a perspective view of two generic ramps 410 and 420 facing each other, each having three tracks, respectively 411a, 411b, 411c and 421a 421b and 421c. Three balls 430a, 430b and 430c roll respectively on the tracks 411a and 421a, 411b and 421b, 411c and 421c. FIGS. 4B to 4C illustrate the position of the balls relatively to their tracks when the ramps 410 and 420 rotate relative to each other. As apparent, because the tracks have radially a spiral shape, the balls, balls 430a, 430b and 430c are held automatically circumferentially, and radially, in a same relative position for all relative rotational positions of the ramps 410 and 420.

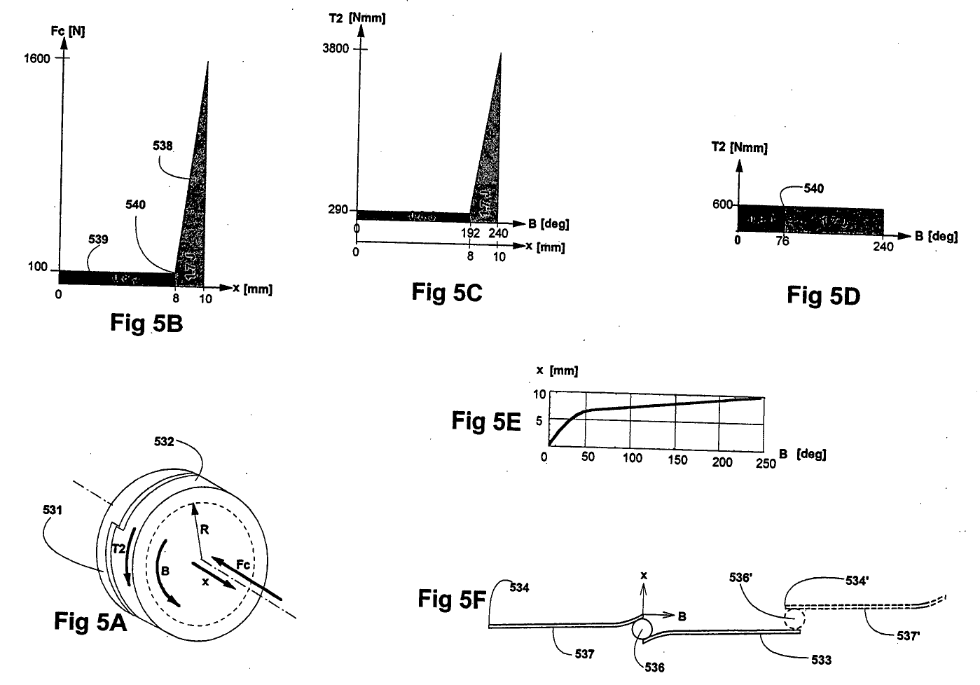

FIG. 5A is a schematic of a generic ball ramp system having a non rotating ramp 531 and a rotating ramp 532, and is used for the definition of the various parameters used in FIGS. 5B to 5F. Fc is the axial reaction force applied to the ramp 532 by the control levers, B and x are respectively the angle of rotation and the axial movement of the ramp 532, T2 is the external control torque necessary to rotate the ramp 532 consequent to the force Fc. Finally R is the radius of the tracks of the ramps 532 and 531 when assuming that said tracks lay at a constant distance R from the axis of rotation of the ramp 532.

The following description of FIGS. 5A to 5F makes reference to the parts of the first ball ramp system 300a. Said description is identical for the second ball ramp system 300b.

FIG. 5B illustrate the reaction force of the clutch levers (i.e. the control force Fc) as a function of the axial travel (control travel x) of said control levers. For example, for the clutch loaded by the lever 101a when the control travel x varies between 0 and 8 mm, the control force Fc may start at around 100 N and reach about 120 N at the kissing point. The kissing point 540 is defined as the point were the pressure plate touches the disc, and is typically reached for a control travel x of 8 mm. Thereafter, while the control travel x varies from 8 to a maximum of 10 mm, the control force Fc rises almost linearly to a maximum of 1,600 N. About 0.8 Joules is stored in the straps 113a when the control travel x moves between zero and 8 mm, and about 1.7 Joules is stored in the cushion of the disc 102a and the straps 113a when the control travel x moves between 8 mm and 10 mm.

FIG. 5C illustrates the control torque T2 as a function of its rotation B for a constant pitch ramp 532 loaded by the control fore Fc illustrated in FIG. 5B. It should be noted that a constant pitch ramp can be embodied as a screw. The control torque T2 required to rotate the ramp 532 having a constant pitch is proportional to the control force Fc. With a value for the radius R of the ramp typically found in starting clutches, the control torque T2 would vary between 290 Nmm and 3800 Nmm, and its variation is proportional to the force Fc illustrated in the graph of FIG. 5B. Because T2 is proportional to Fc. As illustrated by the double abcissa of FIG. 5C, with a constant pitch ramp, the rotation B of the ramp 532 and the axial travel x are strictly proportional, and it is assumed that the pitch is such that the ramp 532 rotates by 240 degrees when said ramp moves axially by 10 mm, which implies a pitch of 15 mm per turn (or 360 degrees).

When the pitch of the ramp 532 is continuously variable instead of constant, it is possible to design the ramps such that the torque T2 remains constant when the ramp 532 rotates, in spite of the variation of the control force Fc. In this case, the same amount of energy, i.e. 2.5 Joules, is transferred into the clutch, but the torque T2 has the lowest possible value, and therefore the rated torque of the motor is also at its minimum. In order to achieve this, the pitch, i.e. the relation between an infinitesimal rotation dB and the correspondent infinitesimal axial movement dx, varies by design continuously along the track. The pitch is therefore continuously variable and is calculated such that, for any given axial position x, the torque T2 consequent to the force F2 is constant, in spite of the wide variation of F2 as illustrated in FIG. 5B. In this case as shown in FIG. 5D, for the first part of the control (from clutch open to the kiss point 540), the control travel x varies by 8 mm for a rotation B of 76 degrees, and for the second part of the control (between the kiss point 540 and clutch fully closed), the control travel x varies by 2 mm for a rotation B of 164 degrees. In the first part of the control a relatively small rotation of the shaft of the motor 111a results in a relatively high travel of the pressure plate 102a, and in the second part of the control, a large rotation of the shaft of the motor 111a results in a relatively low travel of the pressure plate 102a.

Comparing the FIGS. 5C and 5D it can be observed that the maximum of the torque T2 when the ball ramp system 300a is designed with a constant pitch is about six times higher than for a continuously variable pitch ramp (i.e. 3,800 Nmm versus 600 Nmm), and therefore the maximum torque rating of the motor 111a is six times less when the ball ramp system 300a is designed with a continuously variable pitch.

The relation between the control force Fc and the control travel x is approximately linear for the first part of the control, as well as for the second part, and therefore the equations giving the relation between the control force Fc and the control travel x are respectively Fc=a₁*x+b₁ and Fc=a₂*x+b₂.

The pitch is defined for all values of the rotational position of the ramp 532 directly by the relation between the rotation B and the travel x. For the first and the second part of the control, this relation is as follows:

$$B = \frac{1}{T2} * {[ 0.5 * {a}_{1} * x \hat{} 2 + {b}_{1} * x ]}_{0}^{8} and B = \frac{1}{T2} * {[ 0.5 * {a}_{2} * x \hat{} 2 + {b}_{2} * x ]}_{8}^{10}$$

Using the values of FIG. 5B to define a1, a2, b1 and b2, the variation of B as a function of x was calculated according to the previous formulas and is illustrated in FIG. 5E. It should be noted that the curve has no inflexion point and no discontinuity at x equal to 8 mm, which means that the pitch is continuously variable for all rotational positions B of the ramp 532.

FIG. 5F illustrates an initial position 534 and a final position 534′ of two facing tracks 537 and 533 of the ball ramp systems 300a and 300b, as well as an initial and a final positions of a ball rolling on these tracks, respectively 536 and 536′. In FIG. 5F the tracks are illustrated with the shape defined in the curve of FIG. 5E.

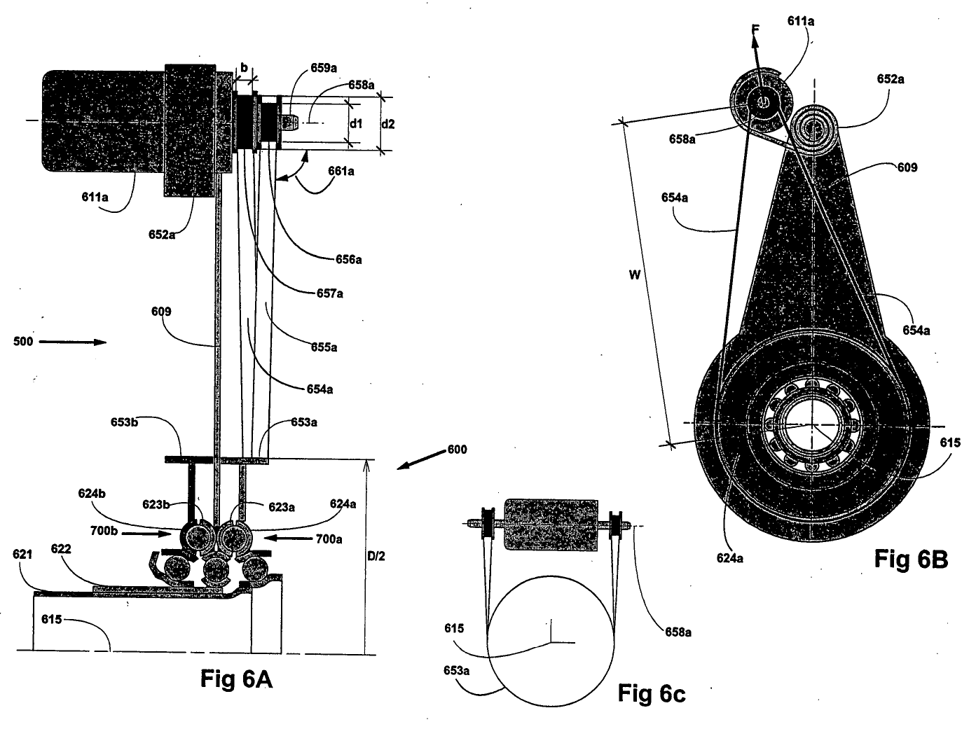

FIGS. 6A and 6B illustrate a dual actuator system 500, an alternate embodiment of the dual actuator system 400 illustrated in FIG. 1 of the drawings. FIG. 6A illustrates a dual actuator system 500 composed of a dual ball ramp system 600 controlled by two motors 611a and 611b (only one is illustrated).

The dual ball ramp system 600 is similar to the dual ball ramp system 200 described in FIGS. 1 to 5F.

The actuator system 500 includes two motors 611a and 611b controlling rotationally a first ball ramp system 700a and a second ball ramp system 700b, both said ramps are coaxial with the axis of rotation 615 of a starting clutch. In FIGS. 6A and 6B, the motor 611b has been removed for clarity.

The actuator system 500 includes the electric motor 611a having two pulleys 656a and 657a fastened to its shaft 659a, and such pulleys having respectively a diameter d1 and a diameter d2 and a width b. In the depicted embodiment, a first end of a band 654a is coiled clockwise on the pulley 656a, wraps the pulley 653a of the ramp 623a, and its other end is coiled counter clockwise on the pulley 657a. Alternatively, the band 654a wraps the pulley 653a for more than one turn, and the wrap angle becomes more than 360 degrees. The two ends of the band 654a are fastened by adequate means to the pulleys 656a and 657a, which may include as non limiting examples adhesive, laser spot weld or a rivet. The portion of the band 654a which is wrapped around the pulley 653a is preferably fastened by adequate means over a relatively short length to said pulley 653a by adequate means, which may include as non limiting examples adhesive, laser spot weld or a rivet. The band 654a is preferably a very thin band or strip of high strength spring steel, which is pre-stressed such that it will wrap tightly around itself in a circular shape in its free state, and having a thickness h in the order of hundredths of a millimeter. Alternatively, and as an example only, the band 654a is weaved, or a composite reinforced by, high strength multifilaments of polymers as a non limiting example, Kevlar or Technora. Because the thickness h is three order of a magnitude lower than the diameters of the pulleys 656a and 657a, and because the shaft 659a rotates about ten turns over the control range, the diameters d1 and d2 for all practical purposes may be considered approximately constant.

A compensation spring 652a is fastened by adequate means on one of its ends to the housing of the starting clutch (not shown) and, on the other end, to the motor 611a, such that the compensation spring 652a applies a constant force F in the direction illustrated in FIG. 6B, with the result that the coil 654a is permanently tighten with a relatively constant force. The compensation spring 652a can be embodied as a spiral spring as illustrated, as a helical torsion spring, or any spring mechanism which supplies a relatively constant force over its range of utilization. As discussed in relation to FIGS. 5A to 5F, the torque T2 required to rotatably control the ramp system 700a is constant over the range of the control, and this translates into a constant torque T1 on the shaft 659a. The ratio between the torque T1 and the torque T2 is equal to

$$\frac{T1}{T2} = \frac{d1 + d2}{2 D}$$

The forces F/2 applied by the band on each pulley generate opposite torques on the shaft 659a. However, these torques are not equal and opposite if d1 and d2 are different, and as a result, a torque T0 is applied to the shaft 659a. The actuator system 500 is designed such that, the torque T0 resulting from the difference in diameter of the pulleys 656a and 656b together with the magnitude of the force F developed by the spring 652a, balances the torque T1 for all control positions. As a result, discounting the friction losses, the power to actuate the starting clutch is theoretically equal to zero.

When the shaft 659a rotates, the distance W varies, and as a result, energy is transferred back and forth between the compensation spring 652a and the shaft 659a of the motor 611a.

In FIGS. 6A and 6B the axis 658a of the motor 611a and the axis of the dual ball ramp system 615 are parallel. It is advantageous to rotate the motor 611a and the compensation spring 652a by 90 degrees (not illustrated), such that the axis 658a of the motor and the axis 615 of the dual ball ramp system 600 are perpendicular, and the pulleys 656a and 657a are separated by a distance approximately equal to (D-b). In this case, the coil 655a uncoils from the pulleys 656a and 657a with an angle 661a equal to about ninety degrees.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. In a dual clutch system having a first and a second friction disk and having a first and a second pressure plate, a clutch actuator comprising:
a first fixed ramp and second fixed ramp, each of said first and said second fixed ramps being disposed to closely cooperate with a first bearing and a second bearing, respectively;
a first moveable ramp and a second moveable ramp, said first and said second moveable ramps being disposed to closely cooperate with said first bearing and said second bearing respectively, a first release bearing, said first release bearing being adapted to move a first lever, said first release bearing being actuated by movement of said first moveable ramp;
a second release bearing, said second release bearing being adapted to move a second lever and said second release bearing being actuated by movement of said second moveable ramp;
said first and said second levers being disposed to operatively bias the first and second pressure plates;
a cover bearing, disposed to support movement of said first and second moveable ramps and said first and second release bearings;
each of said moveable ramps being actuated by a linkage with a separate motor.

2. The apparatus of claim 1 wherein at least one of said ramps is spiral.

3. The apparatus of claim 1 wherein at least one of said ramps has a constant pitch.

4. The apparatus of claim 1 wherein at least one of said ramps has a variable pitch.

5. The apparatus of claim 1 wherein at least one of said ramps has a continuously variable pitch configured and disposed to draw a constant torque from said motors through a range of motion of said ramp.

6. The apparatus of claim 1 wherein said ramps are channels in disks.

7. The apparatus of claim 1 wherein at least one of said moveable ramps moves a range of about zero to 192 degrees, said movement causing an axial movement of at least one of said levers substantially about 8 millimeters.

8. The apparatus of claim 7 wherein at least one of said moveable ramps moves a first range of about zero to 240 degrees, said movement causing an axial movement of at least one of said levers substantially about 10 millimeters.

9. The apparatus of claim 1 wherein at least one of said moveable ramps moves a first range of about zero to 76 degrees, said movement causing an axial movement of at least one of said levers substantially about 8 millimeters.

10. The apparatus of claim 9 wherein at least one of said moveable ramps moves a second range of about 76 degrees to about 164 degrees, said movement causing an axial movement of at least one of said levers substantially about 2 millimeters.

11. The apparatus of claim 1 wherein at least one of said ramps is co-axial with an axis of rotation of said dual clutch.

12. The apparatus of claim 1 wherein at least one of said ramps is comprised of a first portion having a first pitch and a second portion having a second pitch.

13. The apparatus of claim 12 wherein a curvature of said at least one ramp between said first portion and said second portion is continuous.

14. The apparatus of claim 1 wherein said linkage from said motor to said at least one ramp is a pulley, said pulley turning a band, said band being in operative engagement with said pulley and said ramp.

15. The apparatus of claim 14 wherein said band is comprised of composite reinforced by high strength monofilament polymers.

16. The apparatus of claim 14 wherein a first end of said band is wrapped in a first rotational direction around a shaft of said motor and an opposite end of said band is wrapped in opposite rotational direction around said shaft of said motor.

17. The apparatus of claim 14 wherein said band is steel.

18. The apparatus of claim 17 wherein said steel band is pre-stressed.

19. The apparatus of claim 17 wherein said steel bands are in a range of between approximately one hundredth and one thousandth of a millimeter in thickness.

20. The apparatus of claim 14 wherein said bands are woven.

21. The apparatus of claim 14 wherein said pulley is suspended by a compliant spring.

22. The apparatus of claim 14 wherein said at least one of said motors is mounted with an axis of rotation perpendicular to the axis of said clutch.

23. The apparatus of claim 21 wherein said compliant spring exerts a substantially constant force on said band, said force being substantially radial to an axis of rotation of at least one of said ramps.

24. The apparatus of claim 21 wherein said spring is spiral.

25. The apparatus of claim 21 wherein said spring is a helical torsion spring.
